(19) United States
(12) Patent Application Publication
(10) Pub. No.: US 2002/0156881 A1
(43) Pub. Date: Oct. 24, 2002

(54) HTTP transaction monitor with replay capacity

(76) Inventors: Ana H. von Klopp Lemon, San Francisco, CA (US); George C. Finklang, San Francisco, CA (US)

Correspondence Address: ROSENTHAL & OSHA L.L.P., 1221 MCKINNEY AVENUE, SUITE 2800, HOUSTON, TX, 77010, US

(21) Appl. No.: 09/789,238

(22) Filed: Feb. 20, 2001

Related U.S. Application Data
(60) Provisional application No. 60/237,823, filed on Oct. 3, 2000.

(51) Int. Cl. G06F 15/173; G06F 15/16

(52) U.S. Cl. 709/224; 709/203

(57) ABSTRACT

A system for monitoring HTTP transactions between a server and a client includes a data collector which runs on the server and collects data from HTTP requests sent by the client to the server and data from the HTTP responses sent by the server to the client. The system also includes a graphical display which displays the collected data and through which replay requests are sent to the server, each replay request specifying a prior HTTP request to be interpreted by the server. The system also includes a request player which runs on the server and modifies each replay request with a portion of the collected data associated with the prior HTTP request to be interpreted by the server.

### CROSS-REFERENCE TO RELATED APPLICATIONS

This application claims priority from provisional application serial no. 60/237,823, filed Oct. 3, 2000. This application is related to original U.S. application Ser. No. 09/730,686, filed Dec. 6, 2000.

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office file or records, but otherwise reserves all copyright rights whatsoever.

### TERMINOLOGY

The following glossary of some terms are helpful in understanding the background discussion and the detailed description of the invention.

API (Application Programming Interface)—An interface for application programs and utilities to access the internal services provided by the software that comprises the API.

Applet—A Java™ program embedded in a HTML document and executed in a Java™-enabled browser.

ASP™ (Active Server Pages™)—A scripting environment developed by Microsoft Corporation. ASP™ allows HTML, scripts, and ActiveX components to be combined to create dynamic web pages.

Bean—A JavaBeans™ component.

Class—A user-defined data type that defines a collection of objects that share the same characteristics. An object is one instance of the class.

Client—A program, often including a user interface, which initiates contact with another program (a server) for the purposes of exchanging data. The server runs in a different process and/or on a different host from the client.

Cookie—A packet of information sent by an HTTP server to a web browser and then sent back by the browser each time the browser accesses the same resource on the server or any other set of resources that is declared by the cookie.

Cookies are used to maintain state between HTTP transactions. Cookies are not visible to the browser user.

DHTML (Dynamic HTML)—An extension of HTML. DHTML gives greater control over the layout of page elements and the ability to have web pages which change and interact with the user without having to communicate with the server.

Directory—A simulated file folder on disk.

E-commerce (Electronic commerce)—Typically implies purchasing products via the Web. It also covers electronic data interchange, in which one company's computer queries and transmits purchase orders to another company's computer.

Execution Server—An HTTP server that is used by an IDE for the purposes of assisting with the processes of developing dynamic web components. The IDE uses the execution server to run JSPs and servlets, or dynamic page generation components in general.

CGI (Common Gateway Interface)—A standard for running external programs from a HTTP server.

CGI Script—A small program written in a script language such as Perl that can be invoked through a request to the web server.

GUI (Graphical User Interface)—A graphics-based interface that incorporates, for example, icons, menus, and text entry areas and allows for non-linear user interaction (as opposed to character-based interfaces where the user enters data by answering questions in a set order).

Hook—Programming instructions that provide breakpoints for future expansion. Hooks can be used to call some outside routine or function or may be places where additional processing is added.

HTML (HyperText Markup Language)—A hypertext document format used on the World Wide Web.

HTTP (Hypertext Transfer Protocol)—An application-level protocol for distributed, collaborative, hypermedia information systems.

HTTP Request—A message sent by a client to a server using HTTP. The first line of the request contains the method to be applied to the resource requested, the identifier of the resource, and the protocol version in use. The first line is followed by HTTP headers, lines which provide information about the client, which are optionally followed by a data stream.

HTTP Response—A message sent to a client after the HTTP server receives and interprets a request message from the client. The first line of the response includes the protocol version used by the server and a success or error code. The first line is followed by HTTP headers with information about the server and about the (optional) body content that follows the headers as a data stream.

HTTP Server—A server process which processes HTTP requests.

HTTP Session—Part of the Java Servlet™ APIs. Allows the HTTP server to maintain state between different HTTP requests. The HTTP server knows which session to associate with the request because the browser sends the session ID as part of the request. This can either be done with a cookie or by adding a parameter to the request URL.

IDE (Integrated Development Environment)—An application that facilitates the process of writing software. An IDE typically includes a syntax-based editor, graphical tools for program entry, and integrated support for compiling, executing, and debugging the program.

IDE Session—The instance of an IDE (and all its internal states) that is created when the user starts up and uses the IDE. The session ends when the user exits the IDE instance.

Internal HTTP Server—Sometimes referred to as internal server. An HTTP server that runs in the same process of an application for the purposes of providing services to it.

JavaBeans™—A component software architecture that runs in the Java™ environment, initially developed by Sun Microsystems, Inc. JavaBeans™ allows developers to create reusable components that can be assembled together using a visual application builder tool.

JSP™ (JavaServer Pages™)—A specification to extend the Java™ Servlet API to generate dynamic web pages on a web server. It includes a set of tags in XML format for creating dynamic content in web pages. In order to use JSP™ on a web server, the web server needs a JSPTM engine and a servlet engine. The JSP™ engine is responsible for generating a servlet from the JSP™ page and maintaining a name convention such that the servlet is invoked when the JSP™ page is processed. JSP™ was developed by Sun Microsystems, Inc.

JSP™ Page—A text-based document that uses fixed template data and JSP™ elements and describes how to process a request to create a response. The template data consists of JSPTM tags embedded in static content which is typically HTML.

LRI (Local Resource Identifier)—The location of a resource relative to the hierarchical structure of the server, e.g., a path relative to the server's document root if the resource is a file.

Plug-in—An auxiliary program that works with a major software package to enhance its capability.

Process—An executing program with its own internal data states that are not accessible to other processes.

Web Resource—A network data object or service that can be identified by a URI.

Server—An application program that accepts connections in order to service requests by sending back responses.

Servlet—A Java™ program that runs exclusively in a servlet engine which is an extension to a web server.

URL (Uniform Resource Locator)—A compact string representative of resources available via the network. A URL has the form <protocol>://<server name><LRI><?optional parameters>.

Virtual Machine—A self-contained operating environment that behaves as if it is a separate computer. A Java™ virtual machine is a Java™ interpreter that converts Java byte code into machine language one at a time and then executes it.

Web Browser—A client application that requests resources from a web server, usually for the purpose of displaying them. Examples of browsers are Microsoft® Internet Explorer and Netscape Navigator.

XML (eXtensible Markup Language)—A mark-up language that provides a format for describing structured data.

### BACKGROUND OF INVENTION

1. Field of the Invention

The invention relates generally to web application development processes and systems. More specifically, the invention relates to a method and system for monitoring data flow in a web application, particularly during testing and debugging of the web application.

2. Background Art

A web application is a web site where users can access the information they need and change the state of application logic on a server through a set of web pages. Development of web applications is usually centered around tools and technologies. A web application centered around the Java™ technology may include the following: JSP™ pages and Java™ servlets that handle HTTP requests and generate dynamic content, server-side beans that encapsulate application behavior and state, static HTML files, DHTML files, image files, sound files, and libraries with additional Java™ components, such as client-side Java™ applets and any Java™ class files used by the other Java™ components. The J2EE™ specification describes a standard for how to organize such files into web modules, including describing how they are accessed. The web modules could be developed in an IDE, such as sold under the trade name Forte™ for Java™ by Sun Microsystems, Inc.

The process of test-running and debugging web applications that provide dynamic responses to different user inputs involves testing each component that generates pages with every possible type of user input. This includes user input that is technically incorrect (e.g., entering “&&ˆ ˆ %” into a field where the expected input is a U.S. zip code). To understand how the test-running and debugging process works, it is useful to consider a specific example. Consider a portion of a web application that deals with entering billing and shipping addresses for the purpose of allowing the user to purchase goods or services. Assume that the web application includes page-generation components JSP_A and JSP_B, respectively. Components JSP_A and JSP_B could be JSPTM pages, for example. JSP_A generates a page A that displays an HTML form in a browser where the user can enter billing and shipping addresses and press a “Continue” button to submit the information. Pressing the “Continue” button causes the browser to make a HTTP request to JSP_B with the data from the form fields as request parameters. If the address information is valid, JSP_B generates a page B which displays the addresses as text and asks the user to confirm that the addresses are correct. If the address information is invalid (e.g., because of a missing phone number or a zip code which contains characters other than digits), JSP_B forwards the request back to JSP_A, which regenerates page A with some extra messages that point to invalid entries.

Now, suppose that the user has identified a problem with how the input from page A is processed by JSP_B. In this situation, the user will attempt to fix the bug and then re-execute JSP_B with the same input from page A. In this situation, it is clearly desirable for the user to be able to resubmit the request from page A without having to reenter the same data into the page's input fields. However, this may not be possible for several reasons. First, it is common for dynamically generated pages to include a HTTP directive which specifies that the page should not be cached (by the browser or by a proxy server). This means that the browser's “Back” or “Reload” button would not populate the page's input fields with the previously entered data. Using the “Back” button would cause the form from which the HTTP request was created to be regenerated, losing any data that was previously entered. With reference to the example above, this means that if the user used the “Back” button to display page A, all the data the user previously entered on page A would be lost, so the user cannot just select the “Continue” button to resubmit the same request. The user can work around this by disabling the directive, but that involves extra work and remembering to enable it again later.

Similarly, using the “Reload” button to regenerate page B with the same input data might fail, though this depends on the implementation of the browser. Some browsers, e.g., Netscape Navigator, cache HTTP requests as well as HTTP responses, enabling the user to use the “Reload” button to resubmit the same request even if the resulting page has a directive that prevents it from being cached. However, there are situations where this might not work either, such as when the problematic input from page A causes page B to redirect or forward the request to page A. Of course, caching HTTP requests also only works until the request is dropped from the browser's cache. This will typically happen if the browser window is used to display some other pages, or if the browser process is terminated.

The only way that the user can ensure that the request can be resubmitted is by creating a bookmark for it. However, browsers typically do not make it possible to specify that the URL should be sent as a POST request, which is how data from a form is usually sent. This leaves the user with the possibility of hard-coding the data values for a particular POST request on a specific web page that is used for testing purposes only. This again is not a very attractive option. In short, there is no easy way for users to debug HTTP requests that result from HTML forms, especially if the work stretches over time. Sooner or later the user will have to fill in the same data again, which is time consuming and does not contribute directly to solving the problem. Therefore, what is desired is a mechanism that will allow the user to repeatedly submit a HTTP request with the same HTTP headers and parameters.

### SUMMARY OF INVENTION

In one aspect, the invention relates to a system for monitoring HTTP transactions between a server and a client. The system comprises a data collector which runs on the server and collects data from HTTP requests sent by the client to the server and data from HTTP responses sent by the server to the client. The system further includes a graphical display which displays the collected data and through which replay requests are sent to the server, each replay request specifying a prior HTTP request to be interpreted by the server. The system further includes a request player which runs on the server and modifies each replay request with a portion of the collected data associated with the prior HTTP request to be interpreted by the server.

In another aspect, the invention relates to a system for monitoring data flow in a web application. The system comprises a server which hosts the web application and a client which accesses components of the web application by sending HTTP requests to the server and receiving HTTP responses from the server. The system further includes a data collector which runs on the server and collects data from the HTTP requests and the HTTP responses. The system further includes a graphical display which displays the collected data and through which replay requests are sent to the server, each replay request specifying a prior HTTP request to be interpreted by the server. The system further includes a request player which runs on the server and modifies each replay request with a portion of the collected data corresponding to the prior HTTP request to be interpreted by the server.

In another aspect, the invention relates to a method for monitoring data flow in a web application. The method comprises using a client to send a HTTP request to a server hosting the web application and using the client to receive a HTTP response from the server. Prior to the server executing the HTTP request, the method includes determining if the HTTP request is a replay request which specifies a prior HTTP request to be interpreted by the server. If the HTTP request is a replay request, the method includes modifying the HTTP request with request data associated with the prior HTTP request to be interpreted. The method further includes collecting data from the HTTP request prior to the server interpreting the HTTP request and collecting data from the HTTP response prior to the server sending the HTTP response to the client. The method further includes displaying the collected data in a graphical display.

Other aspects and advantages of the invention will be apparent from the following description and the appended claims.

### BRIEF DESCRIPTION OF DRAWINGS

FIG. 1 is a block diagram of a testing/debugging system incorporating a HTTP transaction monitor according to one embodiment of the invention.

FIG. 2 shows a GUI for the HTTP transaction monitor in accordance with one embodiment of the invention.

FIG. 3 shows the GUI of FIG. 2 integrated with an IDE.

FIG. 4 is an illustration of how the server-side component shown in FIG. 1 operates in accordance with one embodiment of the invention.

### DETAILED DESCRIPTION

Embodiments of the invention provide a tool for replaying HTTP requests during testing and debugging of a web application. The tool allows a user to resend any current or saved HTTP requests with the same HTTP headers and parameters as the HTTP request that initiated that transaction. One of the advantages of the tool of the present invention is that a user can replay a transaction which requires parameters that are set by entering input on a HTML form without having to fill out the form again. This allows a problem encountered during processing of the form data to be reproduced quickly, reducing testing and debugging time.

Another advantage of the tool of the present invention is that a user can resend requests that were originally made from a separate web browser which has a different configuration and potentially runs on a different operating system. For example, suppose that the user is debugging a web application that is sensitive to the locale setting of the browser that makes the request, where locale setting indicates what language the user wants to use and certain formatting preferences. The HTML pages generated by the web application should display text in the language preferred by the user or in English if the language is unsupported. With the present invention, the user can make requests for a resource using different locale settings, e.g., Chinese or Swedish, and then store these requests as saved transactions. The user can then use the tool to replay those transactions exactly as they were in order to verify that the resource behaves correctly for the different languages without reconfiguring the browser.

Another advantage of the tool of the present invention is that a web developer can rapidly test an e-commerce application by creating and storing the data needed to execute the checkout process and then using the stored data to verify the checkout process. For example, suppose that a web developer is testing an e-commerce application, specifically a part of the checkout process that comes after the user has entered the shipping address. Further, assume that the application is set up in such a way that the user is not allowed to enter the checkout process unless one or more products have been selected. The web application keeps track of products selected using an electronic shopping cart, which is typically part of the HTTP session. The shopping cart is emptied whenever the dynamic component, e.g., JSP™ page, that the web developer needs to examine has executed. In this case, the developer can use the tool of the present invention to store one or more request that will populate the shopping cart and one that enters the shipping address.

To test the dynamic component without the tool of the present invention, the web developer would first have to access a product page and use the product page to add a product to the shopping cart. Then the web developer would have to start the checkout process, display the form for the shipping address, enter data and submit the form. This process would have to be repeated every time the web developer wants to test the dynamic component. With the tool of the present invention, the process is much simpler. The web developer replays the transactions that populate the shopping cart and whatever transactions are needed to start the checkout process and enter the shipping address. This saves time that would otherwise be needed to manually populate the shopping cart and enter the shipping address. Once the data is entered, the web developer can proceed with verification of the dynamic component.

In the description of the invention which follows, a web application which contains JSPs™ and servlets is used in illustrating the principles of the invention. However, it would be understood by one of ordinary skill in the art that the principles of the invention are applicable to web applications containing other types of dynamic page generation components such as ASPs™ and CGI scripts. Also, for convenience, the following description is outlined into five principal sections, including Architecture overview, Directory Structure, HTTP Transaction Monitor GUI, HTTP Transaction Monitor Server-Side Functionality, and Operation.

Architecture Overview

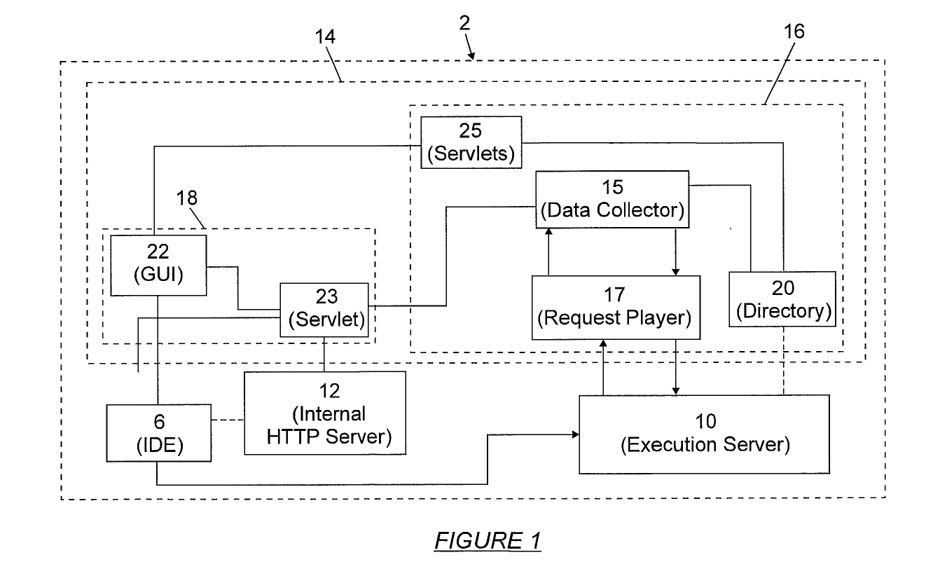

FIG. 1 shows a block diagram of a testing/debugging system 2 which includes an embodiment of the invention. The testing/debugging system 2 includes an IDE 6 which can be used to design, compile, execute, test, and debug components of a web application. In one embodiment, the IDE 6 is a Java™ application which contains bytecodes that are interpreted by a Java™ Virtual Machine (not shown). However, the IDE 6 may be written in other programming languages, e.g., C++. When the IDE 6 is started, a GUI (not shown) is displayed through which a developer can develop and/or view the components of the web application. Further, the IDE 6 can execute the web application components in a HTTP server that is running in a separate process. This HTTP server will be referred to as the execution server 10. The execution server 10 may be started, for example, when a user selects a file representation of a JSP™ page (not shown) from the IDE 6. The execution server 10 may be on the same host machine as the IDE 6 or may be on a different host machine.

In accordance with one embodiment of the invention, a HTTP transaction monitor 14 includes a server-side component 16, which collects data about HTTP transactions on the execution server 10, and a client-side component 18, which displays the collected data. The HTTP transactions can either be initiated by the IDE 6 or through an external HTTP client, e.g., a browser, pointed to the host and port of the execution server 10. The server-side component 16 comprises a data collector 15 that is responsible for collecting data before and after the execution server 10 processes the HTTP requests. In one implementation, the IDE 6 includes a mechanism through which the data collector 15 can notify the HTTP transaction monitor 14 of requests processed by the execution server 10. This mechanism can be a HTTP server 12 which is built into the IDE 6 and configurable from the IDE 6. If the HTTP transaction monitor 14 is run as a standalone application, then the HTTP transaction monitor 14 would be responsible for maintaining the mechanism through which it is notified when the execution server 10 processes a new HTTP request

In one implementation, the data collector 15 runs on the execution server 10 and relies on hooks in the execution server 10 to intercept HTTP requests in order to collect data about them. In an alternate embodiment, the data collector 15 uses hooks in a server plug-in (e.g., a servlet engine) that handles the dynamic components of the web application to intercept HTTP requests in order to collect data about them. The server-side component 16 further comprises a notification mechanism which notifies the client-side component 18 when a HTTP request has been processed so that the client-side component 18 can update its transaction list. In one implementation, the data collected by the data collector 15 is stored as one or more files in a directory 20 on the execution server 10 and managed by the server-side component 16. In this implementation, the notification mechanism sends the client-side component 18 sufficient data to display the transaction corresponding to the HTTP request. In another implementation, the data files are sent to and managed by the client-side component 18.

The server-side component 16 also includes a request player 17 that detects a special type of HTTP request (“replay request”) sent by the client-side component 18. The replay request indicates that a prior HTTP request should be replayed and contains sufficient information to recreate the prior HTTP request. The request player 17 modifies the replay request to be identical to the original request before passing it on. The modified request is then processed by the data collector 15 before control is yielded to the execution server 10. The request player 17 runs on the execution server 10. In one implementation, the request player 17 relies on hooks in the execution server 10 or hooks in a server plug-in (e.g., a servlet engine) to intercept replay requests coming into the execution server 10. The request player 17 replaces all the request data, i.e., the IP address of the client from which the HTTP request originated, the HTTP method, the request URI, the protocol version, any query string and parameters, and all the HTTP headers, in the replay request with the corresponding data from the HTTP request that is to be replayed. The data needed to modify the replay request may be loaded directly from the directory 20 or may be passed in as parameters with the replay request (i.e., if the data is managed by the client-side component 18).

In one implementation, the client-side component 18 is accessible from the IDE 6. The client-side component 18 includes a GUI 22 which displays the transactions for which the server-side component 16 has collected data. The GUI 22 also allows the user to send a request to the execution server 10 to replay a prior HTTP transaction. The client-side component 18 further includes a mechanism for receiving notification of new HTTP transactions, which are subsequently listed on the GUI 22. In one embodiment, this functionality is handled by a servlet 23 which runs on the internal HTTP server 12 and is called whenever the server-side component 16 records a new transaction.

### Directory Structure

In one implementation, the directory 20 is treated as part of the server-side component 16 and is installed as a web module on the execution server 10. In alternative embodiments, the directory 20 may be maintained by the client-side component 18. The contents of the directory 20 include the following: a subdirectory “current” and a subdirectory “save.” The subdirectory “current” contains files with the data from each transaction that has been recorded in the current IDE session and which has not been saved. The subdirectory “save” contains files with the data for each transaction that has been saved. It should be noted there could be other ways of keeping track of whether the transactions are current or saved. The current transactions may be deleted when the IDE session is terminated in order to save disk space.

For each HTTP transaction that the execution server 10 processes, the categories of data shown in Table 1 below are collected. The data can either be stored in a single structure file (e.g., an XML file), which is processed by the client-side component 18, or can be stored as several files in a directory that is specific to the transaction.

TABLE 1
Categories of Data Collected by Server-Side Component

| Category | List of Data Collected |
|---|---|
| Request | The IP address of the host from which the request was sent, |
| | the HTTP method, the LRI, path information (if |
| | appropriate), the query string, the protocol version, the |
| | referrer (if appropriate), the value of any incoming |
| | parameters, and the exit status of the HTTP response. |
| Cookies | List of incoming and outgoing cookies. For incoming |
| | cookies, the name and value is provided. For outgoing |
| | cookies, the name, value, domain, time to live, path and |
| | whether the cookie requires secure protocol. |
| Session | Whether the session exists before and after the transaction. |
| | Which attributes were set and what their values are before |
| | and after the transaction. The session's properties: its ID, |
| | when it was created, its maximum inactive interval, and |
| | when it was last accessed. |
| Servlet | Name of the servlet as configured, its class name, its |
| Properties | package name, the description given by the developer, and |
| | the relative path to the servlet. The servlet's initialization |
| | parameters, if there are any. The absolute path to the |
| | J2EE ™ context. The servlet engine's properties (Java |
| | Development Kit and platform). |
| Client | The version of the HTTP protocol, the client's IP address, |
| | any other information provided through the HTTP headers |
| | such as the nature of the client, e.g., the type and version of |
| | the browser, the user's language preference, and what |
| | formats and character sets the browser can deal with. |

In addition to collecting data for the purpose of displaying information about the transaction, the data collector 15 generates the information required to list the transaction in the GUI 22. This information can either be included in a single structured data file (e.g., an XML file), or it can be stored in a separate file in a directory corresponding to the transaction. In one embodiment, this information includes the ID of the transaction, the HTTP method, the LRI of the request, and timestamp of the transaction. Additional data may be included to generate more detailed list entries.

In one implementation, the directory 20 is maintained as part of a web module. In this implementation, the web module includes a set of servlets which manage the directory 20. The servlets are invoked by the client-side component 18 when the user wishes to display data about a request or save or delete a request. Such a web module could run either on the execution server 10 as part of the server-side component 16 or on the internal HTTP server 12. In FIG. 1, the web module is part of the server-side component 16, where the servlets in the web module are indicated collectively at 25. The servlets 25 perform the following functions: serve up data from the files stored in the “current” and “save” subdirectories, delete records corresponding to one or more transactions, move records up from the “current” subdirectory to the “save” subdirectory, and serve up a list of all current and saved transactions.

In another implementation, the directory 20 is maintained directly by the client-side component 18, in which case there is no need for servlets 25 to manage the data. In this implementation, the client-side component 18 can use normal file operations to access the data.

### HTTP Transaction Monitor GUI

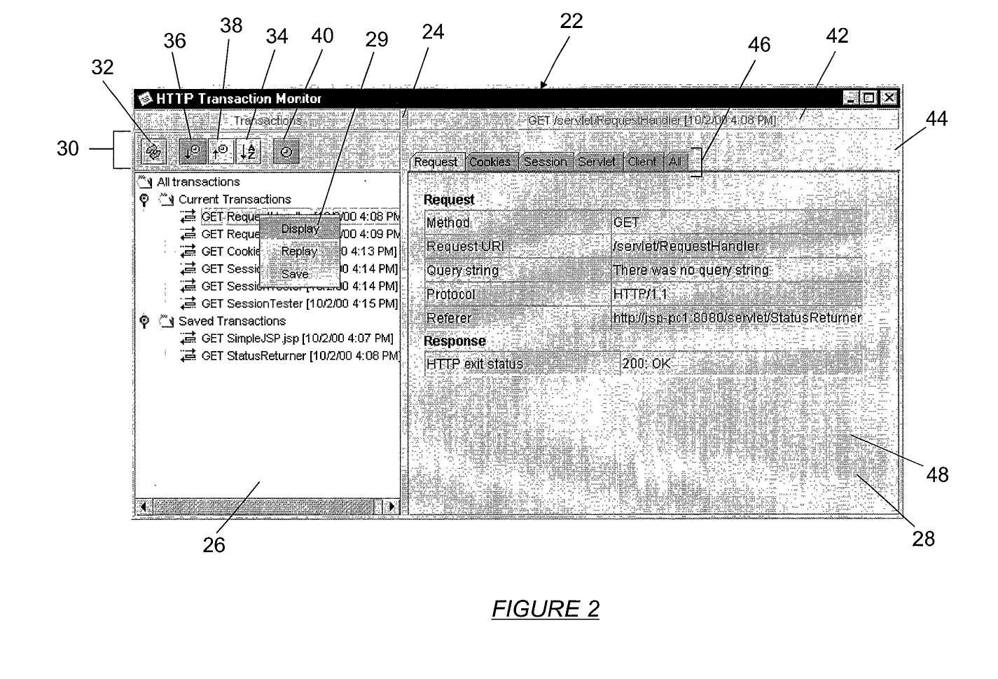

FIG. 2 is a screenshot of one embodiment of the GUI 22 (previously shown in FIG. 1). In one implementation, the GUI 22 is a software component or application that can be called from within the IDE (6 in FIG. 1). In the illustrated embodiment, the GUI 22 comprises a single frame 24 having a left pane 26 and a right pane 28. The GUI 22 displays a list of transactions on the left pane 26 and data for an individual transaction on the right pane 28. The left pane 26 of the GUI 22 displays one supercategory node “All Transactions.” Under the supercategory “All Transactions” are subcategory nodes “Current Transactions” and “Saved Transactions.” Individual transactions are leaf nodes and reside in either the “Current Transactions” subcategory or the “Saved Transactions” subcategory. Entries in the “Current Transactions” subcategory are available during the current IDE session, while entries in the “Saved Transactions” subcategory persist until they are deleted by the user. The entries in the “Current Transactions” and “Saved Transactions” subcategories are obtained from the “current” and “save” subdirectories in the directory (20 in FIG. 1).

Individual transaction nodes in the “Current Transactions” subcategory have three actions: “Display,” “Replay,” and “Save.” In the “Saved Transactions” subcategory, the individual transaction nodes have three actions: “Display,” “Replay,” and “Delete.” In one implementation, the list of actions available under each transaction category is displayed in a pop-up menu 29 when the user right-clicks on a transaction. The “Display” action causes data about the corresponding transaction to be shown in the right pane 28. The data can also be displayed simply by selecting the node. In one implementation, the “Save” action sends a message to the execution server (10 in FIG. 1) to mark the corresponding transaction records as saved. This assumes that the directory (20 in FIG. 1) is installed as a module on the execution server (10 in FIG. 1). If the directory (20 in FIG. 1) is maintained by the client-side component (18 in FIG. 1), the “Save” action causes the client-side component (18 in FIG. 1) itself to perform this task. Similarly, the “Delete” action causes the records for the corresponding transactions to be deleted and removes the deleted transaction's node from the GUI 22.

The “Replay” action causes the original HTTP request to be interpreted by the execution server (10 in FIG. 1). In one implementation, the HTTP response is displayed in the same browser that the IDE (6 in FIG. 1) uses to display HTTP responses from JSPs™ that are executed through the IDE (6 in FIG. 1). In an alternate embodiment, if the HTTP transaction monitor (14 in FIG. 1) is used as a standalone tool, the HTTP response may be displayed in an external browser. The user can configure the HTTP transaction monitor (14 in FIG. 1) to use a browser of choice.

Each of the nodes corresponding to the parent categories “All Transactions,” “Current Transactions,” and “Save Transactions” have a “Delete” action which causes the individual transactions underneath them to be deleted. Invoking the “Delete” action on the “All Transactions” category deletes all transaction entries and removes all nodes from the GUI 22. Invoking “Delete” action on “Saved Transactions” deletes all saved transactions and removes the node in the “Saved Transactions” category. Invoking “Delete” action on “Current Transactions” deletes all current transactions and removes the node in the “Current Transactions” category. A row of buttons 30 above the transaction list allows the user to reload all transactions and to modify display parameters. The button 32 reloads all the transactions. The button 34 displays the transactions in alphabetical order, by LRI. The button 36 displays the transactions in temporal order, last transaction last. The button 38 displays the transactions in reverse temporal order, last transaction first. The button 40 toggles whether the time stamp of the transaction is shown or not.

The right pane 28 of the frame 24 includes a label 42 which displays the LRI and timestamp of the currently selected transaction. The right pane 28 also includes a display component 44 consisting of six tabs 46 and data display 48. In one embodiment, the data display 48 is an embedded HTML browser without toolbar and controls. The six tabs 46 are labeled “Request,” “Cookies,” “Session,” “Servlet,” “Client,” and “All,” respectively. The “Request,” “Cookies,” “Session,” “Servlet,” and “Client,” tabs correspond to five of the six categories of data collected by the server-side component 16 (see Table 1). In FIG. 2, the “Request” tab is selected, causing the data collected on the request and response associated with the transaction selected on the left pane 26 to be displayed inside the data display 48. When the “Cookies” tab is selected, the attributes of incoming and outgoing cookies for the transaction selected on the left pane 26 is displayed inside the data display 48. When the “Session” tab is selected, the session status before and after the transaction selected on the left pane 26 is displayed inside the data display 48. The “Servlet” and “Client” tabs cause servlet properties data and client data, respectively, to be displayed in the data display 48 for the selected transaction. The “All” data causes all the transaction data to be displayed at once in the data display 48.

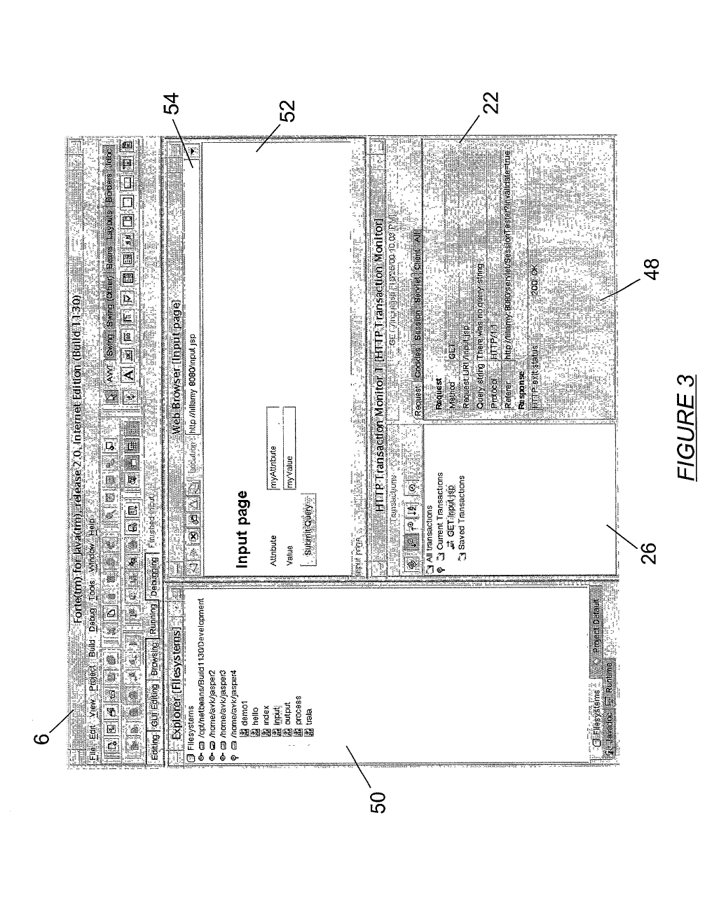

FIG. 3 shows the GUI 22 invoked from within the IDE 6. In the drawing, the IDE 6 is illustrated as the Forte™ for Java™ IDE from Sun Microsystems, Inc. The Internet Edition of the Forte™ for Java™ IDE includes two modules which assist in designing, debugging, executing, and debugging JSP™ pages and servlets. However, it should be clear that the invention is not limited to this particular IDE or for that matter to any IDE. The HTTP transaction monitor of the present invention can be used as a standalone tool with a web server. The invention is also not limited to IDEs that support development of JSP™ pages and servlets. In general, the invention can be applied to any development of web applications.

In the illustrated embodiment, the user can invoke the GUI 22 by selecting the appropriate option in the “Debugging” menu (see FIG. 3) of the IDE 6 or by setting the JSP™/servlet executor property “Show Monitor” to True. The latter method causes the GUI 22 to be displayed every time the JSP™/servlet executor (not shown) is invoked. The former displays the GUI 22 during the IDE session or until it is closed by the user. The IDE session is the period during which the user runs one instance of the IDE 6. The IDE session starts when the user brings up the IDE 6 and ends when the user exits the IDE 6.

HTTP Transaction Monitor Server-Side Functionality

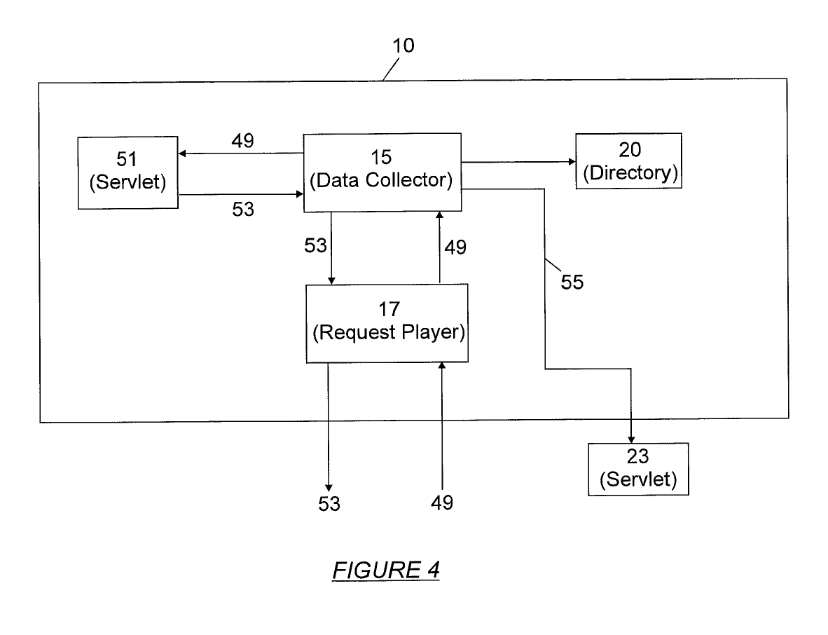

FIG. 4 illustrates how the server-side component 16 operates in accordance with one embodiment of the invention. Suppose that a request 49 is coming into the execution server 10. Before the execution server 10 processes the incoming request 49, the request player 17 intercepts the incoming request 49 and checks whether the incoming request 49 is a replay request. If the incoming request 49 is a replay request, the request player 17 modifies the incoming request 49 with old request data associated with the transaction to be replayed. In one implementation, the URI of the replay request includes a query string with a predefined variable, e.g., “resend.” The query string may have the form “LRI?resend=<id>,” for example. If the query string contains the predefined variable “resend,” then the value of this predefined variable “resend” is the ID that uniquely identifies the “Saved Request” data in directory 20 needed to modify the replay request. If the directory 20 is treated as part of the server-side component 16 and is installed as a web module on the execution server 10, the request player 17 can use the value of the variable “resend” to identify the “Saved Request” data, load the data, and rewrite the replay request. If the directory 20 is managed by the client-side component 18, the “Saved Request” data needed to modify the replay request is passed in with the replay request. After modifying the incoming request 49, the request player 17 yields control to the data collector 15. If the incoming request 49 is not a replay request, the request player 17 immediately yields control to the data collector 15 without modifying the incoming request 49.

The data collector 15 intercepts the incoming request 49 and collects data about the request. The collected data includes information about the client making the request, the session state before the transaction, incoming cookies, servlet properties data, and all the request data except the exit status (see Table 1 above). The data collector 15 then yields control to the execution server 10. The execution server 10 invokes a servlet 51 to process the request. The servlet 51 generates a response 53. After generating the response 53, data collector 15 intercepts the response 53 and collects data about the response 53. This includes information the session state after the transaction, outgoing cookies, servlet properties data, and the exit status of the response 53. The data collector 15 then notifies the client-side component (18 in FIG. 1) by sending a HTTP request 55 to the servlet 23, indicating that a new transaction has been processed. If the recorded data is managed by the server-side component (16 in FIG. 1), then the data is written to the directory 20. If the recorded data is managed by the client-side component (18 in FIG. 1), then the data is sent with the HTTP request 55 to the client-side component (18 in FIG. 1). The data collector 15 then yields control to the request player 17, which simply allows the response 53 to leave the execution server 10.

In one implementation, the request player 17 and data collector 15 rely on hooks on the server to intercept incoming requests and outgoing responses. For the Tomcat web server, for example, two instances of the “RequestInterceptor” API are created to intercept HTTP requests and responses, one for the data collection functionality and the other for the replay request functionality. The Tomcat web server is an open-source software project jointly run by Apache Software Foundation and Sun Microsystems, Inc. The “RequestInterceptor” API provides hooks for invoking methods before and after the HTTP request is processed. In another implementation, hooks in a server plug-in on the execution server 10 are used to intercept HTTP requests and responses. For example, the “Filter” API, as described in the version 2.3 of the Java™ Servlet specification, could be used for the same purpose as the “RequestInterceptor” API.

### Operation

For the developer, the process of developing a web application involves, among other tasks, testing each dynamic web component (in the case of a Java™ application, each JSP™ and servlet) to see that it performs the correct processing and generates the appropriate output. This involves executing individual web components, and also sequences of components as they would be traversed by a user who browses the web site. In the discussion which follows, the web application to be tested has been developed in an IDE, for example, the IDE 6 (shown in FIG. 3). The developer is using the IDE to test-run and debug the web application. The developer can execute the JSP™ pages or servlets from the IDE. The HTTP transaction monitor GUI (22 in FIG. 3) is displayed by either one of the two previously described mechanisms. As shown in FIG. 3, the contents of a web application is displayed in a GUI 50 that is included in the IDE 6. The developer selects a resource in the web application and then asks the IDE 6 to execute the resource For example, in FIG. 3, a JSP™ page called “input” has been selected. To display the page, the IDE 6 sends an HTTP request to the execution server (10 in FIG. 1). The output of the execution server (10 in FIG. 1), i.e., the HTTP response, is displayed in the browser 52 which is included in the IDE 6.

The first thing that happens when the execution server (10 in FIG. 1) receives a HTTP request is that the request player (17 in FIG. 1) examines it to see if it is a replay request. If it is not, the request player (17 in FIG. 1) does not do anything. The data collector (15 in FIG. 1) then intercepts the request and collects data about the request. After collecting the data, control is returned to the execution server (10 in FIG. 1), and the execution server (10 in FIG. 1) processes the request. The execution server (10 in FIG. 1) invokes a servlet (not shown) generated from the JSP™ page with the data that came in with the HTTP request. After processing, the execution server (10 in FIG. 1) sends the response page back to the browser 52. Before the response page is sent to the browser 52, the data collector (15 in FIG. 1) again intercepts the response, collects data on the response, and then yields control back to the execution server (10 in FIG. 1). After collecting data, the data collector (15 in FIG. 1) invokes the servlet (23 in FIG. 1) to update the GUI 22. As shown, a “Get inputjsp” node has been added to “Current Transactions” subcategory on the left pane 26 of the GUI 22. The browser 48 displays the “request” data collected by the data collector (15 in FIG. 1) for the “Get inputjsp” transaction.

Using the data collected by the data collector (15 in FIG. 1), the developer can examine the attributes of requests coming into the execution server (10 in FIG. 1) and responses sent out from the execution server (10 in FIG. 1) through the GUI 22. If a problem arises, the developer can easily find the source of the problem by examining the transactions between the browser 52 and the server (10 in FIG. 1). If a particular request for a resource is one that the developer wants to make regularly throughout the development phase, for instance, in order to verify that the web application continues to work as intended after the changes have been made, then the corresponding HTTP transaction can be saved. This allows the developer to replay the transaction during future IDE sessions. The developer can also use the save functionality in case they wish to defer fixing a problem to a later date. The transaction or transactions corresponding to the requests that reproduce the problem can be saved, giving the developer the opportunity to examine and replay them during a future IDE session. The request player 17 thus saves the developer the trouble of repeatedly accessing the web application resources through a web browser (as a user of the web application would), including reducing the need to fill in HTML forms to generate requests. Because the data collector 15 records data both for regular and replayed requests, it is easy to compare the results from one test-run to another.

Referring to FIG. 1, the server-side component 16 intercepts all requests sent to the execution server 10, not just requests that are initiated from the IDE 6. This means that if the machine on which the execution server 10 is running is networked, then the server-side component 16 could process HTTP requests from clients on other machines. This feature can be useful in the testing phase. Suppose that a test engineer has identified a way of entering data into a web application that causes a problem for one of the dynamic components. Then the web developer could start up the execution server 10 with the server-side component 16. The test engineer can then, on his or her own machine, point a web browser to the host and port of the execution server 10 to access the web application and enter the data that reproduces the problem. The web developer can then use the client-side component 18 to examine what happened with the request and replay it as needed from the developer's own computer.

All HTTP requests that the sever-side component 16 intercepts, whether they originated from the IDE 6, from the client-side component 18 (as a replay request), or from another client, are available to the web developer to replay. With reference to the scenario described in the previous paragraph, suppose that the test engineer accessed two resources in the web application, one for a form and one for submitting the data from the form, resulting in two HTTP transactions on the “Current Transactions” lists. It is the second transaction, i.e., the one for submitting the data from the form, that will be associated with the bug. The web developer could first replay the second transaction to find out what is going wrong. Then the web developer make changes to the web application with the aim to fix the problem. After making the changes, the web developer can then replay the same transaction again, this time to confirm that the bug has been fixed. Replaying the transaction saves the web developer from repeatedly loading the form corresponding to the first request and manually entering the data.

As illustrated above, the invention provides general advantages in that it allows HTTP requests to be stored and replayed at a later time. In the context of testing and debugging applications, the invention saves time because it allows a problem to be rapidly produced without repeatedly entering the same data.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for monitoring HTTP transactions between a server and a client, comprising:
a data collector which runs on the server and collects data from HTTP requests sent by the client to the server and data from HTTP responses sent by the server to the client;
a graphical display which displays the collected data and through which replay requests are sent to the server, each replay request specifying a prior HTTP request to be interpreted by the server; and
a request player which runs on the server and modifies each replay request with a portion of the collected data associated with the prior HTTP request to be interpreted by the server.

2. The system of claim 1, wherein the request player modifies the replay requests prior to the server interpreting the replay requests.

3. The system of claim 2, wherein the request player comprises a process which uses a hook in the server to intercept the replay requests in order to modify the replay requests.

4. The system of claim 2, wherein the request player comprises a process which uses a hook in a server plug-in to intercept the replay requests in order to modify the replay requests.

5. The system of claim 1, wherein the data collector collects data from the HTTP requests prior to the server interpreting the HTTP requests.

6. The system of claim 5, wherein the data collector collects data from the HTTP responses prior to the server sending the HTTP responses to the client.

7. The system of claim 6, wherein the data collector comprises a process which uses a hook in the server to intercept the HTTP requests and the HTTP responses in order to collect data from the HTTP requests and the HTTP responses.

8. The system of claim 6, wherein the data collector comprises a process which uses a hook in a server plug-in to intercept the HTTP requests and the HTTP responses in order to collect data from the HTTP requests and the HTTP responses.

9. The system of claim 1, wherein the collected data are stored in a directory on the server.

10. The system of claim 9, further comprising means for retrieving the collected data from the directory and serving the data to the request player and the graphical display.

11. The system of claim 1, wherein an application which provides the graphical display manages the collected data.

12. The system of claim 1, further comprising means for notifying the graphical display when new data is collected by the data collector.

13. A system for monitoring data flow in a web application, comprising:
a server which hosts the web application;
a client which accesses components of the web application by sending HTTP requests to the server and receiving HTTP responses from the server;
a data collector which runs on the server and collects data from the HTTP requests and the HTTP responses;
a graphical display which displays the collected data and through which replay requests are sent to the server, each replay request specifying a prior HTTP request to be interpreted by the server;
a request player which runs on the server and modifies each replay request with a portion of the collected data corresponding to the prior HTTP request to be interpreted by the server.

14. The system of claim 13, wherein the request player modifies the replay requests prior to the server interpreting the replay requests.

15. The system of claim 14, wherein the request player comprises a process which uses a hook in the server to intercept the replay requests in order to modify the replay requests.

16. The system of claim 14, wherein the request player comprises a process which uses a hook in a server plug-in to intercept the replay requests in order to modify the replay requests.

17. The system of claim 13, wherein the data collector collects data from the HTTP requests prior to the server executing the HTTP requests.

18. The system of claim 17, wherein the data collector collects data from the HTTP responses prior to the HTTP responses leaving the server.

19. The system of claim 18, wherein the data collector comprises a process which uses a hook in the server to intercept the HTTP requests and the HTTP responses in order to collect data from the HTTP requests and the HTTP responses.

20. The system of claim 18, wherein the data collector comprises a process which uses a hook in a server plug-in to intercept the HTTP requests and the HTTP responses in order to collect data from the HTTP requests and the HTTP responses.

21. A system for testing and debugging a web application, comprising:
a server which hosts the web application;
a client which accesses components of the web application by sending HTTP requests to the server and receiving HTTP responses from the server;
a data collector which runs on the server and collects data from the HTTP requests and the HTTP responses;
a graphical display which displays the collected data and through which HTTP replay requests are sent to the server, each HTTP replay request specifying a prior HTTP request to be interpreted by the server;
a request player which runs on the server and modifies each HTTP replay request with a portion of the collected data corresponding to the prior HTTP request to be interpreted by the server;
an application which starts the server in a separate process and through which the graphical display can be accessed.

22. The system of claim 21, wherein the application is an integrated development environment for a web application.

23. The system of claim 22, wherein the client is accessible from within the integrated development environment.

24. The system of claim 22, wherein the application includes an internal server.

25. The system of claim 24, wherein the internal server updates the graphical display with the collected data.

26. A method for monitoring data flow in a web application, comprising:
using a client to send a HTTP request to a server hosting the web application;
using the client to receive a HTTP response from the server;
prior to the server interpreting the HTTP request, determining if the HTTP request is a replay request which specifies a prior HTTP request to be interpreted by the server and, if the HTTP request is a replay request, modifying the HTTP request with request data associated with the prior HTTP request to be interpreted;
collecting data from the HTTP request prior to the server interpreting the HTTP request;
collecting data from the HTTP response prior to the server sending the HTTP response to the client; and
displaying the collected data in a graphical display.

27. The method of claim 26, wherein the replay request is initiated through the graphical display.
